(19) United States
(12) Patent Application Publication
(10) Pub. No.: US 2006/0021316 A1
(43) Pub. Date: Feb. 2, 2006

(54) Disc cutterbar shear device

(76) Inventor: Melanie W. Harkcom, New Holland, PA (US)

Correspondence Address: CNH AMERICA LLC, INTELLECTUAL PROPERTY LAW DEPARTMENT, PO BOX 1895, M.S. 641, NEW HOLLAND, PA, 17557, US

(21) Appl. No.: 10/900,758

(22) Filed: Jul. 28, 2004

(51) Int. Cl. A01D 34/63

(52) U.S. Cl. 56/255

(57) ABSTRACT

A one-piece disc cutterbar shear device that employs frangible structural members between the drive shaft and knives, the frangible members designed to fail before the drive components upon impact with an obstruction.

### FIELD OF THE INVENTION

The present invention relates generally to mechanisms for protecting mechanical drive components from overloads, and more particularly relates to a shear device coupled between components of an agricultural disc mower that protects the various components of the mower in the event a cutterhead strikes an object and creates an overload condition.

### BACKGROUND OF THE INVENTION

Typical disc cutterbars used in agriculture include an elongated housing-containing a train of meshed idler and drive spur gears, or a main power shaft coupled by respective bevel gear sets, for delivering power to respective drive shafts for cutterheads spaced along the length of the cutterbar. The cutterheads each comprise a cutting disc including diametrically opposed cutting blades (though configurations with three or more blades are known) and having a hub coupled to an upper end of a drive shaft, the lower end of the drive shaft carrying a spur gear in the case where a train of meshed spur gears is used for delivering power, and carrying a bevel gear of a given one of the bevel gear sets in the case where a main power shaft is used. In either case, as would be expected, bearings are used to support the various shafts. The cutterheads are rotated at a relatively fast speed making the drive components, such as gears, bearings, and shafts vulnerable to damage in the event that the unit strikes a foreign object. For background information on the structure and operation of some typical disc cutterbars, reference is made to U.S. Pat. No. 4, 815,262 issued to E. E. Koch and F. F. Voler, the descriptive portions thereof being incorporated herein in full by reference.

In order to minimize the extent of such possible damage to the drive components, it is known to incorporate a shear device somewhere in the drive of each unit which will fail upon the imposition of a predetermined overload. As used herein with reference to shear devices, the terms “fail” or “failing” are intended to cover the actual function of such devices, i.e., shearing, fracturing, breaking and the like. Several different such shear devices and arrangements are shown, for example, in U.S. Pat. Nos. 4,999,981, 4,497,161 and 5,715,662.

The '981 patent shows a shear mechanism that comprises a shaft with a weakened portion created by a cut groove, or break zone 41 (seen, for example, in FIG. 3 thereof) in driven shaft 20. Upon overload, the shaft breaks at zone 41 which is located outside the support bearing such that there is a clean and complete break in the shaft. This structure is intended to eliminate the input of kinetic energy to the cutterhead after failure of the shear mechanism, thereby eliminating damage to the drive system and gearing.

A somewhat different shear mechanism is disclosed in FIGS. 2 and 3 of the '161 patent. Cutting disc 3 is connected by a series of shear bolts 26 to the vertical shaft 8. Upon impact of the cutterhead with an obstruction, one or more of the shear bolts fail, stopping the input of rotational force to the cutterhead. FIG. 4 shows a slightly different embodiment where a resilient cover plate 28 depresses balls 30 arranged in holes of the disc 3 and fitting into recesses 31 of the disc 27. An overload impact is intended to cause balls 30 to snap out of the recesses 31 so that the direct rotary joint between shaft 8 and cutting disc 3 is interrupted. It is stated that the connection can be re-established by continuing to rotate disc 3 with respect to the disc 27 so that the balls 30 again snap into the recesses 31.

The shear mechanisms shown in the '662 patent each employ shearable splines. In a first embodiment the shear device is in the form of either a collar or clamping member having internal splines received on a splined upper end of the drive shaft and having shearable cylindrical drive lugs engaged with complementary shaped openings provided in an upper surface of a disk hub. Referring more specifically to FIG. 2 thereof, the upper end of drive shaft 26 has a splined section 86. Shear collar 88 establishes a drive connection between shaft 26 and hub 80. The collar 88 includes internal splines 90 engaged with the splined section 86 of shaft 26 just above hub 80. Shearable cylindrical drive lugs 92 project downwardly from the bottom of collar 88 and are received in complementary holes 94 in hub 80. An overload situation causes the lugs 92 to shear and the continuing transfer of rotational power to cease. FIGS. 4 through 6 show another embodiment where shaft 34 has a splined upper end section 110. Instead of a shear collar, a shear device in the form of a cap-like clamping member 114 is used for transferring torque from shaft 34 to hub 80. Clamping member 114 has an annular lower portion 116 provided with interior splines 118 engaged with the splined section 110 of shaft 34. A plurality of shearable lugs 120 extend downward from lower portion 116 and are received in complementary shaped cylindrical openings 94 in hub 80, whereby torque is transferred from shaft 34 to hub 80. Again, when an overload occurs, lugs 120 shear, and torque is no longer transmitted. The final embodiment shown in the '662 patent is shown in FIGS., 7 through 9. Instead of a disk hub 80, a disk hub 127 is used which has a central splined opening 128 disposed in spaced concentric relationship to the splined upper end section 110 of shaft 34. A ring-like shear insert 130 is received on the upper end of the drive shaft 34 and has inner splines 132 engaged with the splined upper end section of the shaft and has outer splines 134 engaged with the splined opening 128 of hub 126. Splines 132 are designed to shear upon overload. Shearable splines do work; however, shearing splines has the potential of lodging metal fines (small pieces that may accompany the shearing process) into the support bearing(s). Additionally, the splines must be reduced in number or weakened in order to shear properly, thus potentially reducing their longevity.

Another significant and generally universal problem with shear systems that use mating surfaces, such as shear pins or splines, is that mating surfaces wear during normal cutterbar operation leading to premature failure.

It would improve the operation of disc cutterbars if the problems identified above could be overcome.

### SUMMARY OF THE INVENTION

Accordingly, an object of the present invention is to provide a shear mechanism in a mechanical drive train for an agricultural cutterbar that will stop the transfer of power along the drive train in the event of overload.

A further object of the present invention is to provide a novel shear device between components of a cutterhead.

A further object of the present invention is to provide a novel shear device between components of a cutterhead that has no mating surfaces which wear and lead to premature fatigue failure.

Yet another object of the present invention is to provide a disc cutterbar with multiple cutterheads, each comprising a drive shaft connected via a single-piece shear hub to the knives of the cutterhead.

It is a still further object of the present invention to provide a shear mechanism in a mechanical drive train for an agricultural cutterbar that can be easily removed and replaced upon failure.

It is yet a further object of this invention to provide an improved disc cufterbar that is relatively durable in construction, inexpensive of manufacture, carefree of maintenance, easy to assemble, simple and effective in use, and less likely than prior art cutterbars to sustain costly damage upon contact with a fixed object.

These and other objects, features and advantages are accomplished according to the instant invention by providing a one-piece disc cutterbar shear device that employs frangible structural members between the drive shaft and knives, the frangible members designed to fail before the drive components upon impact with an obstruction.

### DESCRIPTION OF THE DRAWINGS

The advantages of this invention will be apparent upon consideration of the following detailed disclosure of the invention, especially when taken in conjunction with the accompanying drawings wherein:

FIG. 1 is a top plan view of a disc mower mounted on the three-point hitch of a tractor, the disc mower having a modular disc cufterbar incorporating the principles of the instant invention, the rotational path of the individual disc members being shown in phantom, the disc mower being one of the configurations in which the improved disc cuttterbar of the instant invention can be utilized;

FIG. 2 is an enlarged top plan view of a central portion of the assembled modular disc cutterbar depicting two adjacent cutterhead modules and an interstitial spacer module, portions of the spacer modules on opposite sides of the cutterhead modules being broken away and the disc members being removed for clarity;

FIG. 3 is a cross-sectional view of the cutterhead module taken along line 3-3 of FIG. 1; and

FIG. 4 is a perspective view of the shear device of the instant invention.

### DESCRIPTION OF THE PREFERRED EMBODIMENT

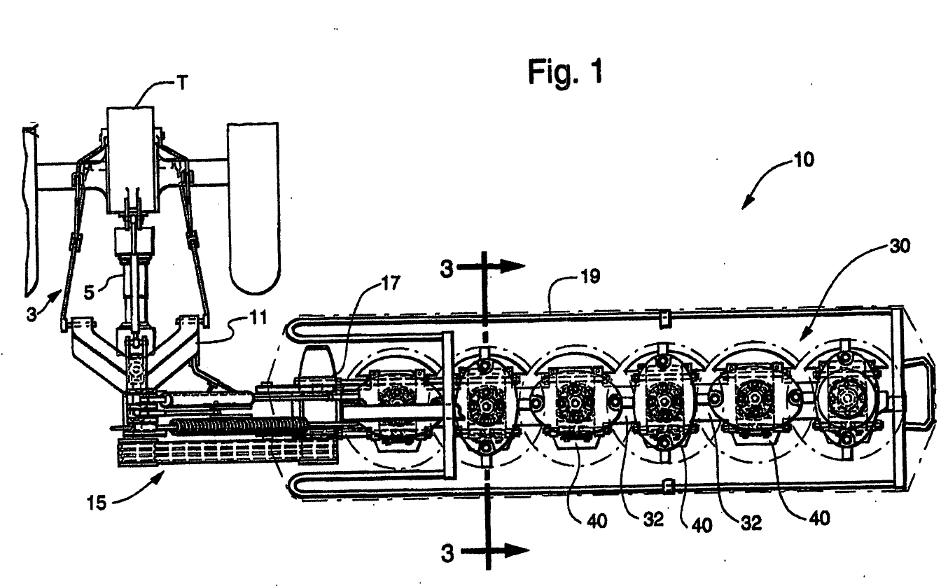

Referring now to the drawings and particularly to FIG. 1, a modular disc cutterbar incorporating the principles of the instant invention can best be seen in a configuration in which the disc cutterbar is conventionally utilized. For a more detailed description of a conventional modular disc cutterbar and various configurations thereof reference is made to U.S. Pat. No. 5,996,323. The disclosure in that patent is hereby incorporated herein in its entirety by reference.

Cutterbar 30 is mounted in a disc mower 10 having a support frame 11 connected to the three-point hitch mechanism 3 of a tractor T on which the mower 10 is carried in a conventional manner. The disc mower 10 receives operative power from the conventional tractor power take-off shaft 5. The mower drive mechanism 15 receives the rotational power from shaft 5 and transfers the rotational power to a gearbox 17, which in turn transfers the rotational power to the cutterbar drive mechanism.

An alternative configuration for the disc cutterbar would be to incorporate the cutterbar in a disc mower-conditioner. This well-known configuration is shown in more detail in U.S. Pat. No. 5,761,890, which is hereby incorporated herein in its entirety by reference. One skilled in the art and knowledgeable about commercial applications of disc cutterbars will readily recognize that there are other specific configurations of cutterbars to which the invention to be disclosed herein will be applicable. Such skilled individual will also readily recognize that the cutterbar need not necessarily be modular in construction.

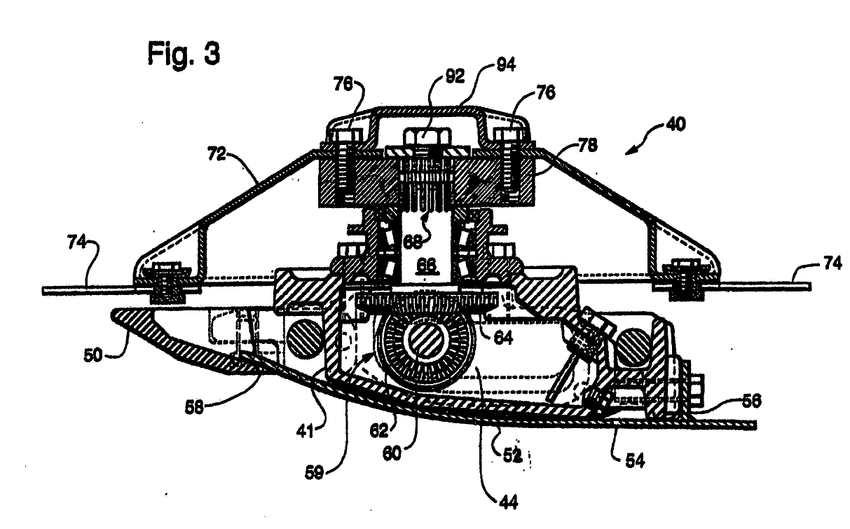

Modular cutterbar 30 is formed from alternating cutterhead modules 40 and spacer modules 32. Each cutterhead module 40, as best seen in FIGS. 1-3, includes a hollow cast housing 41 (FIG. 3) having a shape to retain a low profile and to establish an oil reservoir 44 therewithin. Cutterheads 40 are gear driven and assembled in such a manner as to establish a specific timing relationship between adjacent units. More particularly, the cutterheads are arranged such that the knives 74 on adjacent units have overlapping cutting paths, but do not come into contact with each other. Failure to maintain this timed relationship during operation will result in one unit hitting the adjacent unit(s), damaging the cutterheads (and possibly initiating a chain reaction that damages all cutterheads), the drive train of the cutterbar and/or tractor T.

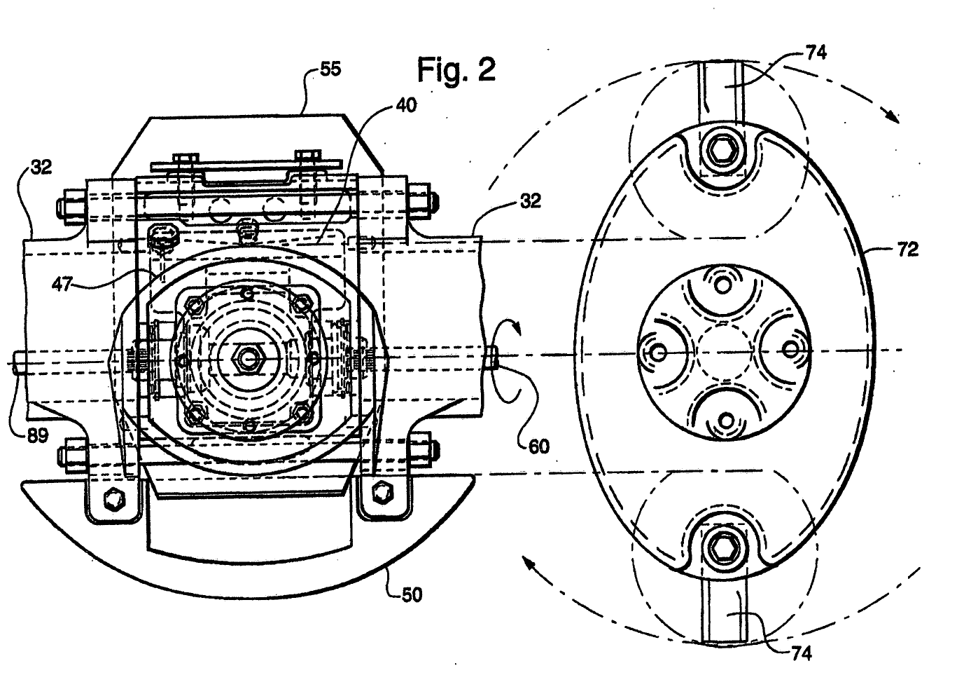

Referring again to FIGS. 2 and 3, it can be seen that each cutterhead module 40 is provided with a forwardly positioned rock guard 50 and a skid shoe 52 that passes beneath cutterhead module 40 for engagement with the surface of the ground. The rock guard 50 has a conventional semi-circular configuration and is mounted to opposing forward mounting arms of spacer module 32 adjacent to the corresponding cutterhead module 40.

One skid shoe 52 is mounted beneath each cutterhead module 40 to protect the cutterhead module from wear due to engagement with the surface of the ground. Each skid shoe is formed as a generally planar body portion 54 with a mounting tab 56 affixed thereto and projecting upwardly. The body portion 54 is also formed with a forward end 58 that is bent upwardly to engage the corresponding rock guard 50.

Modular drive mechanism 59, best seen in FIGS. 2 and 3, is fully disclosed in the '323 patent and reference is made thereto for a more complete description.

In a simplified manner the drive structure for the cutterhead will now be described in reference to FIG. 3. The horizontal drive shaft 60 transfers rotational power along the length of the cutterbar 30. Shaft 60 is either one long shaft or a series of smaller interconnected shafts extending between adjacent cutterheads 40. Bevel gear pairs 62, 64 convert the horizontal rotational power in shaft 60 to vertical rotational power in drive shaft 66. The top end portion of drive shaft 66 has splines 68 cut therein, making a male splined shaft, for attaching hub 78 as will be explained further below.

Cutterhead cover 72 is either pressure formed or fabricated in a bowl-like configuration to provide protection to the underlying components and a support for knives 74. The number and means for attachment of knives may vary, but are well-known features of such mechanisms. Affixed by to a central opening in cover 72 is splined hub 78.

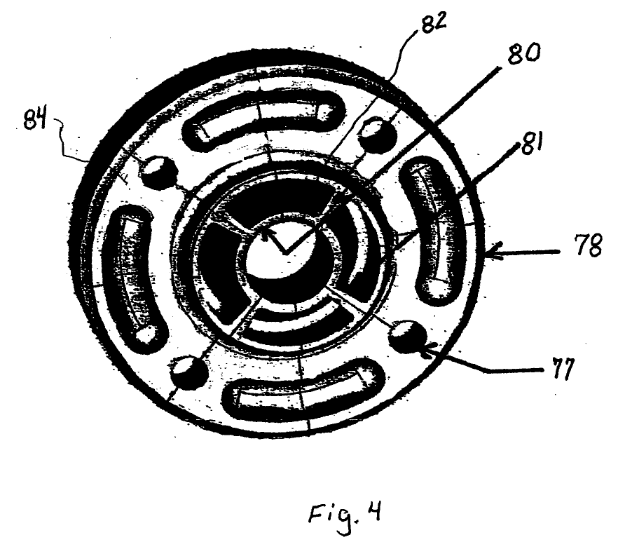

Hub 78 is, as can best be seen in FIG. 4, a disk-like member symmetrical about its central vertical axis, and includes a central splined through opening 80 contained within a generally cylindrically-shaped collar-like portion 82. A generally ring-like outer portion 84 of hub 78 contains a plurality of annularly-space bolts 76, threaded into holes 77 in hub 78, and additionally fix movement of the outer portion 84 of hub 78 with cover 72 and knives 74. Collar-like inner portion 82 is fixed relative to, and supported by, outer portion 84 by a plurality of web members 81. Web members 81 are made of a frangible material, such as, for example, powdered metal, and designed with such dimensions as are necessary to cause the webs to fail at a specified torque or impact force. The failure forces required to cause the web to fail are, obviously, determined to cause minimum damage to the drive components, yet adequate to allow the effective operation of the cutterhead. Hub 78 may be fabricated in several different ways to achieve the required characteristics and elements. It may, for instance, be cast of a single material with the dimensions of the web members being such that the required failure point is met. Additionally, the inner collar-like portion 82 may be totally supported by web members 81, or, portion 82 may be supported by web members 81 and a relatively thin flat inward continuation of the outer portion 84 (that does not cover opening 80). Such a structure, while functional, would result in additional debris at the time of failure.

The hub 78 can be located on the underside of the cover 72 or on the upper side, depending upon the cutterhead profile desired. The hub is affixed to cover 72 by bolts 76 which may also attach a smaller cover 94 to prevent bolts 76 from unnecessary or premature wear. Hub 78 is affixed to drive shaft 66 by bolt and cap washer 92 that tightens vertically into the end of shaft 66 to hold the hub in place to rotate with the drive shaft.

When the cutterhead engages a fixed object of sufficient mass or rigidity to generate a shearing force on web members 81, adequate to cause failure thereof, the outer portion 84 of hub 78 and the drive shaft 66 will separate and power will cease to be transferred to the knives 74, thus preventing further damage.

The drive mechanism 59 in each cutterhead module 40 is coupled to the other cutterhead module drive assemblies by a transfer shaft 60 that passes through the spacer module 32, as best depicted in FIG. 2.

Referring now to the configurations of utilization of the cutterbar 30 as depicted in FIG. 1, it can be seen that the drive mechanism 59 in a disc mower 10 receives rotational power from a gearbox 17 that is supported adjacent the inboardmost cutterhead module 40. Accordingly, the drive assembly is connected directly to the output shaft (not shown) of the gearbox 17. The transfer of rotational power to the remaining cutterhead modules 40 proceeds as described above.

It will be understood that changes in the details, materials, steps and arrangements of parts which have been described and illustrated to explain the nature of the invention will occur to and may be made by those skilled in the art upon a reading of this disclosure within the principles and scope of the invention. The foregoing description illustrates the preferred embodiment of the invention; however, concepts, as based upon the description, may be employed in other embodiments without departing from the scope of the invention. Accordingly, the following claims are intended to protect the invention broadly as well as in the specific form shown.

Having thus described the invention, what is claimed is:

1. A disc cutterbar having a support member with a cutterhead affixed thereto, said cutterhead including a disc member carrying a knife to sever standing crop material, said disc member having a mounting hub provided with a central mounting through hole, said mounting hub comprised of a ring-like outer body member generally symmetrical about said through hole and a ring-like inner body member generally symmetrical about said through hole and having an inner surface with splines formed therein, said inner and outer body members generally concentric with each other and said through hole, said inner and outer body members interconnected by a plurality of radial webs, said disc member drivingly connected to said hub, a drive including a splined drive shaft received in said mounting hole for rotation of said hub and disc member about an upright axis; said hub coaxially affixed to said drive shaft such that the splines on said drive shaft drivingly engage the splines on said inner surface of said inner body member such that torque is transferred from said drive shaft through said mounting hub to said disc member, whereby failure of said radial webs on said hub cause the transfer of torque and the rotation of said disc member to cease,

2. The disc cutterbar of claim 1 wherein:
the relative ability to transfer torque of said radial webs extending between said inner and outer body members and said drive shaft are such that said radial webs will fail before said splines on said drive shaft.

3. The disc cutterbar of claim 2 wherein:
said hub and drive shaft are held in position on said drive shaft by a bolt affixed to said drive shaft.

4. The disc cutterbar of claim 3, wherein:
said plurality of radial webs comprises four radial webs.

5. A disc cutterbar comprising:
a support member with a cutterhead affixed thereto;
a disc member affixed to said cutterhead and carrying a knife to sever standing crop material;
a mounting hub in said disc member with a central mounting through hole and comprising first and second ring-like concentric body members, said first body member inside and spaced away from said second body member and interconnected by a plurality of radial webs, said first body member having an inner generally cylindrical splined surface;
said disc member drivingly connected to said hub;
a drive including a splined drive shaft received in said mounting hole for rotation of said hub and disc member about an upright axis, said hub coaxially affixed to said drive shaft such that the splines on said drive shaft drivingly engage the splines on said inner surface of said first body member such that torque is transferred from said drive shaft through said mounting hub to said disc member, whereby failure of said radial webs on said hub cause the transfer of torque and the rotation of said disc member to cease.

6. The disc cutterbar of claim 5 wherein:
the relative ability to transfer torque of said radial webs extending between said first and second body members and said drive shaft are such that said radial webs will fail before said splines on said drive shaft.

7. The disc cutterbar of claim 6 wherein:
said plurality of radial webs comprises four radial webs.

8. The disc cutterbar of claim 7, wherein:
said hub and drive shaft are held in position on said drive shaft by a bolt affixed to said drive shaft.

9. In a disc cutterbar having a support member with a cutterhead affixed thereto, a disc member affixed to said cutterhead and carrying a knife to sever standing crop material, a mounting hub in said disc member with a central mounting through hole and comprising a ring-like outer body member generally symmetrical about said through hole, the improvement comprising:
a ring-like inner body member generally symmetrical about said through hole and having an inner surface with splines formed therein, said inner and outer body members generally concentric with each other and said through hole;
said inner and outer body members interconnected by a plurality of radial webs, said disc member drivingly connected to said hub; and
a drive including a splined drive shaft received in said mounting hole for rotation of said hub and disc member about an upright axis, said hub coaxially affixed to said drive shaft such that the splines on said drive shaft drivingly engage the splines on said inner surface of said inner body member such that torque is transferred from said drive shaft through said mounting hub to said disc member, whereby failure of said radial webs on said hub cause the transfer of torque and the rotation of said disc member to cease.

10. The disc cutterbar of claim 9 wherein:
the relative ability to transfer torque of said radial webs extending between said first and second body members and said drive shaft are such that said radial webs will fail before said splines on said drive shaft.

11. The disc cutterbar of claim 10 wherein:
said plurality of radial webs comprises four radial webs.

12. The disc cutterbar of claim 11, wherein:
said hub and drive shaft are held in position on said drive shaft by a bolt affixed to said drive shaft.
